(19) United States
(12) Patent Application Publication
(10) Pub. No.: US 2005/0153765 A1
(43) Pub. Date: Jul. 14, 2005

(54) Electronic memory game

(76) Inventor: Randy M. Shoostine, Washington, DC (US)

Correspondence Address: Richard C. Litman;LITMAN LAW OFFICES, LTD., P.O. Box 15035, Arlington, VA, 22215, US

(21) Appl. No.: 10/752,712

(22) Filed: Jan. 8, 2004

(51) Int. Cl. A63F 13/00

(52) U.S. Cl. 463/9

(57) ABSTRACT

An electronic memory game where individual players or competing players attempt to successfully match signals that are displayed by the game device. The game device includes a housing having an exterior surface and manually operable selection buttons disposed along the exterior surface. A microcontroller for controlling the main functions of the game is stored inside of the housing. The microcontroller generates a number of perceptively differentiable output signals and assigns each output signal to one of the selection buttons. The memory game device also provides an output device for projecting the output signals to the players of the game. The players of the game take turns choosing selection buttons in an attempt to match the output signals corresponding to each selection button.

### BACKGROUND OF THE INVENTION

1. Field of the Invention

The present invention relates to an electronic game, and more particularly to an electronic game in which the players attempt to find matching output signals by selecting buttons corresponding to the specific output signals.

2. Description of the Related Art

The prior art includes a number of educational devices and games that require the user to exercise memory skills to match clues with correct responses.

United Kingdom Application GB 2 068 746 published on Aug. 19, 1981 discloses a talking electronic matching game. The game uses an integrated circuit voice synthesizer to generate a random plurality of beginnings of phrases and a plurality of corresponding ending phrases. The beginnings and endings are assigned at random to a plurality of push buttons that are disposed on the surface of the game device. The object of the game is for the players to match the beginning of the phrases with the corresponding endings of phrases.

U.S. Pat. No. 6,643,656 issued in November, 2003 to Peterson discloses a computerized information retrieval system. The system provides a semantic network that establishes data organization and retrieval. The system also provides a mechanical storage network that locates data in a memory structure. Data is retrieved based on user queries.

U.S. Pat. No. 6,638,168 issued in October, 2003 to Rehkemper discloses a sound elimination game. The game provides a housing supporting a plurality of user depressible buttons. Each button is supported by a light and button assembly and includes a latent image and a means for illuminating the latent image. The lights are selectively illuminated to reveal certain latent images at specific times. The device further activates a sound circuit to provide character sounds associated with the latent images. Gameplay involves matching a particular sound to a particular image.

U.S. Pat. No. 5,906,369 issued in May, 1999 to Brennan et al. discloses a memory game having a game board with a plurality of primary game pieces. The game also provides a plurality of secondary game pieces that are each associated with one of the primary game pieces. The secondary pieces are selectively covered by concealing pieces. Two receptacles are located on the game board and are coupled with a speaker. One of the receptacles receives a primary game piece and one of the receptacles receives a secondary game piece. When placed in the receptacles a sound is emitted. The goal of the game is to match the concealed secondary games pieces with the primary game pieces by matching the sounds.

U.S. Pat. No. 5,855,513 issued in January, 1999 to Lam discloses an electronic matching and position game having a housing with a plurality of spaces defined on the exterior of the housing. Each space has a space input device and a space indicator associated with the space. Inside of the housing is a controller that communicates with each of the space input devices and space indicators. The controller is responsive to activation of a select input device followed by activation of a predetermined space input device. The goal is to match the signal from the select input device with the signal from the space input device.

U.S. Pat. No. 5,411,271 issued in May, 1995 to Mirando discloses an electronic video match game. The game requires the players to match the location of information on a video screen with the correct location of a pushbutton in a corresponding array of pushbuttons. The video screen initially produces a display showing nine object character icons located in nine different locations in a tic-tac-toe arrangement. The icons are then concealed. The video screen then displays one of the icons in a clue box and challenges the player to correctly match the icon in the clue box with its previous location in the array of pushbuttons.

U.S. Pat. No. 5,277,429 issued in January, 1994 to Smith, III discloses a game assembly utilizing sound identification for moves on a game board. The object of the game is for each player to move from the start of the game board to the finish of the game board. The length of each player's move is determined by sound identification. If the player fails to recognize a sound he forfeits his turn. A first player uses a keyboard to identify a randomly generated sound, while a second player attempts to anticipate the random sound by moving panels over certain keys on the keyboard.

U.S. Pat. No. 5,122,062 issued in June, 1992 to Cutler et al. discloses an electronic teaching apparatus. The educational teaching apparatus is disclosed for use in learning key subjects. The device uses information cards that store visual question and answer data. The device compares user input answer data with the memory stored correct answer data.

U.S. Pat. No. 4,363,482 issued in December, 1982 to Goldfarb discloses a sound-responsive electronic game. The electronic game facilitates the playing of a sequence parlor game. The game generates a series of player-interrogation signals and defines a corresponding correct sequence of auditory and switch closure responses by the players. The correct sequence is defined in accordance with established game rules that are known to the players. The game receives the players' responses and compares them to the correct sequences and then indicates whether or not the player's response is correct.

U.S. Design Pat. Nos. 268,602 and 268,603 issued in April, 1983 to Lee each disclose the ornamental design for an electronic memory game housing. The memory games provide a plurality of buttons disposed on the exterior surface of a housing.

The prior art documents fail to provide electronic memory games that disclose all of the features of the present invention. The prior art documents fail to teach a memory game that can be played by a single player or by multiple players in several different game modes. The prior art documents also fail to disclose electronic memory games that allow the players to input their own images, sounds or videos to be used as the indicators to be matched during gameplay.

None of the above inventions and patents, taken either singly or in combination, is seen to describe the instant invention as claimed. Thus an electronic memory game solving the aforementioned problems is desired.

### SUMMARY OF THE INVENTION

The electronic memory game of the present invention is a memory game where individual players or competing players attempt to successfully match signals that are displayed by the game device. The electronic memory game is based on the principles of the children's game of Memory. The game device comprises a housing having an exterior surface and a number of manually operable selection buttons disposed along the exterior surface of the housing. A microcontroller for controlling the main functions of the memory game is stored inside of the housing. The microcontroller generates a number perceptively differentiable output signals and assigns each output signal to one of the selection buttons. The memory game device also provides an output device for projecting the output signals to the players of the game. The output signals may include, images, sounds, written words, videos, drawings, characters or symbols.

The memory game device also includes a gameplay display that is disposed on the exterior surface of the housing for displaying specific gameplay information, such as the score. Also, a gameplay control panel is disposed on the exterior surface of the housing for controlling specific aspects of the gameplay. The gameplay control panel is used for altering the volume of the device as well as selecting specific games modes. The memory game device may be played in several different modes, but generally the game may be played in a single player or multi-player mode.

Accordingly, it is a principal object of the invention to provide an electronic memory game based on the general principles of the common children's game Memory.

It is another object of the invention to provide an electronic memory game that is easily played in either a single player mode or a multi-player mode.

It is a further object of the invention to provide an electronic memory game that allows the players to input data into the device to use as signals during gameplay.

Still another object of the invention is to provide an electronic memory game that can manipulate the data inputted by the players.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an electronic memory game according to the present invention.

FIG. 2 is a front perspective view of the electronic memory game.

FIG. 3 is a top perspective view of the electronic memory game according to a second embodiment.

FIG. 4 is a top perspective view of an additional embodiment of the electronic memory game.

FIG. 5 is a top perspective view of an additional embodiment of the electronic memory game.

FIG. 6 is a top perspective view of an additional embodiment of the electronic memory game.

FIG. 7 is a top perspective view of an additional embodiment of the electronic memory game.

FIG. 8 is an environmental, perspective view of an additional embodiment of the electronic memory game.

FIG. 9 is a block diagram of the internal components of the electronic memory game.

FIG. 10 is a top perspective view of another embodiment of the electronic memory game.

Similar reference characters denote corresponding features consistently throughout the attached drawings.

### DETAILED DESCRIPTION OF THE PREFERRED EMBODIMENTS

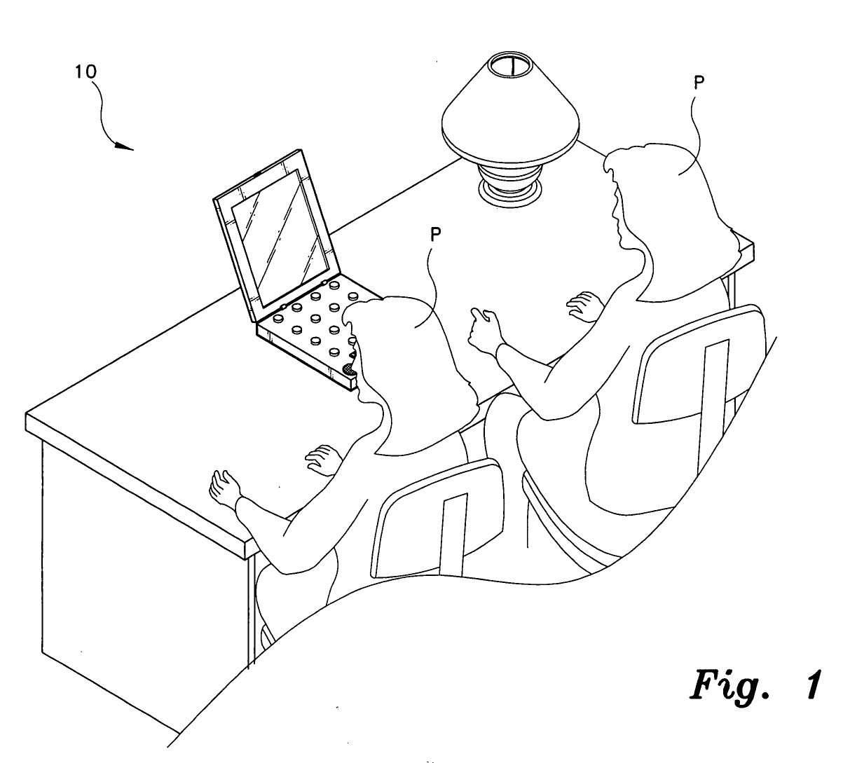

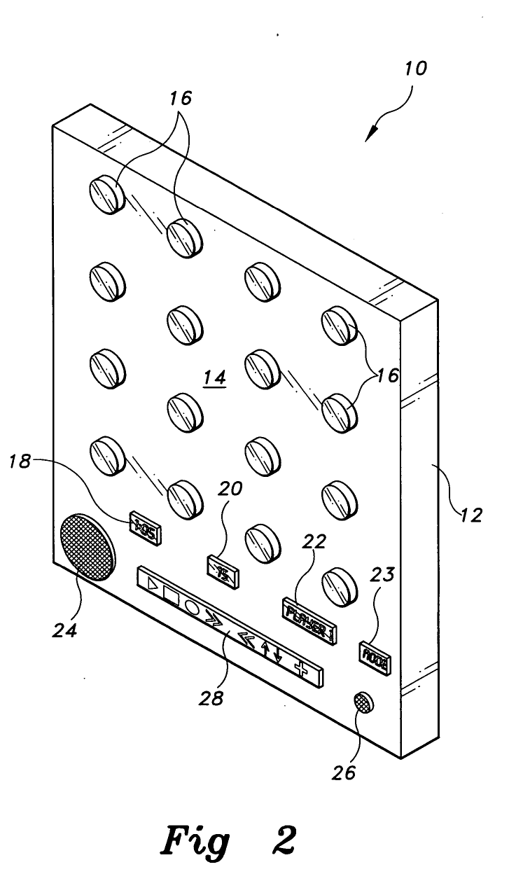

The present invention is an electronic memory game based on the general principles of the common children's game Memory, where individual players or multiple players attempt to match sets of indicia. FIG. 1 is an environmental perspective view of the electronic memory game device 10 being used by two players P. FIG. 2 is a perspective view of the electronic memory game device according to a preferred embodiment of the present invention. The memory game device 10 comprises a housing 12 having a top exterior surface 14. The housing 12 supports all of the exterior components of the memory game device 10 on its top exterior surface 14 and also stores all of the internal components of the memory game device 10. The housing 12 may be made from any material that is suitable to support and protect the components of the memory game including, but not limited to, metal and plastic.

A plurality of manually operable selection buttons 16 is disposed along the top surface 14 of the housing 12. Each of the buttons 16 represents a card that would be used in the traditional game of Memory. Each button 16 will have specific electronic data associated with it and the object of the game is to locate as many matching buttons 16 as possible.

The electronic memory game device 10 further comprises a gameplay display disposed along the top surface 14 of the housing 12. According to certain preferred embodiments of the present invention, the gameplay display provides a time display 18, a score display 20, a player turn display 22 and a mode display 23. The player turn display 22 indicates which player P currently has control of the game device 10. The score display 20 indicates the current player's P score during that player's P turn. When a first player P is in control, that player's P score is displayed. When a second player P is in control, that player's P score is displayed. The time display 18 may function to display several different time features including the amount of time elapsed in the current player's P turn, the amount of time elapsed during the entire game or the amount of time left in the current player's P turn or the entire game. Each of the three displays may be positioned separately on the board, as shown in FIG. 2, or as a single gameplay display. The gameplay display may also include additional displays including game level, game mode and game settings.

The game device 10 further provides a gameplay control panel 28 disposed along the top surface 14 of the housing 12. The gameplay control panel 28 provides several controls for operating the general features of the game device 10. The gameplay control panel 28 provides a volume control, a play button, a stop button, a record button and controls for selecting game modes including the number of players and the type of game being played. The control panel 28 also allows the players P to add and delete data and to select certain data to be used during the game.

The game device 10 also includes an output device for projecting the specific output signals associated with each selection button 16. In the present embodiment shown in FIG. 2 the output device is a speaker 24 disposed on the top surface 14 of the housing 12. In the current embodiment, each selection button 16 has a specific auditory sound that matches one or more other selection buttons 16 to form a set of matching selection buttons 16. The output signal associated with the set of matching selection buttons 16 is perceptively differentiable from sounds associated with the other buttons 16. When a button 16 is depressed by the player P, the corresponding sound associated with that button 16 is projected through the speaker 24.

Optionally, the game device 10 may provide an input device so that the players P may input their own signals to be associated with the selection buttons 16. In the present sound-only embodiment of the game device 10, the input device is a microphone 26. The microphone 24 allows the players P to input sounds or voices into the game device 10. Optionally, the game device 10 may provide a microphone port for receiving a handheld microphone.

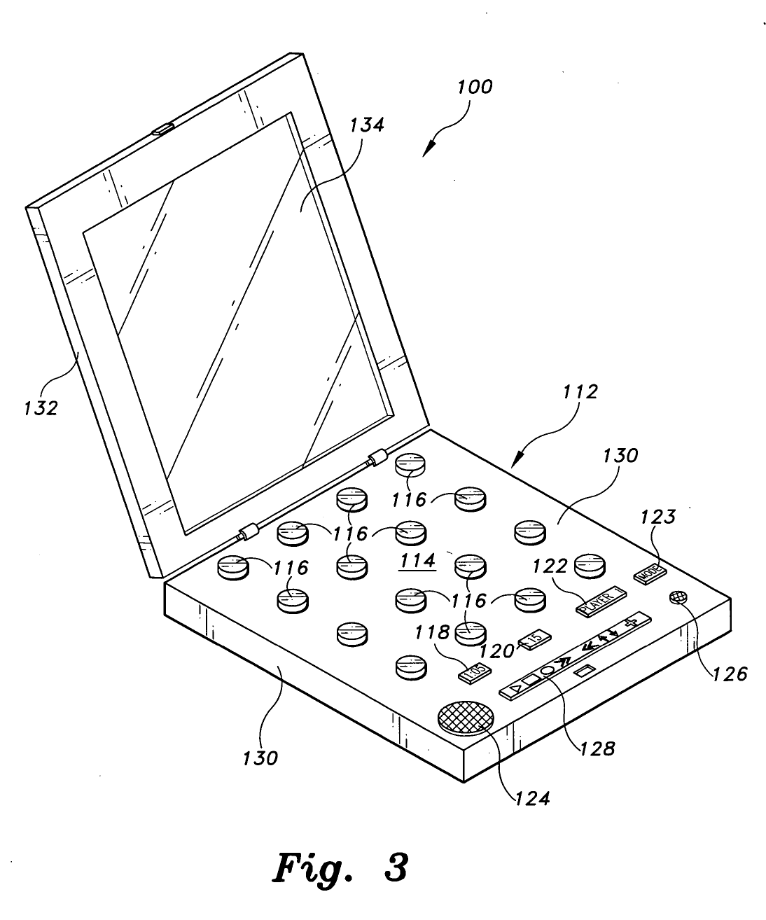

FIG. 3 is a top perspective view of an electronic memory game device 100 according to a second embodiment of the present invention. The present game device 100 can associate visual, as well as auditory, signals with the selection buttons 116. The present game device 100 generally comprises the same features described for the sound-only game device 10. The game device 100 comprises a housing 112 with an exterior top surface 114, having a plurality of selection buttons 116 disposed on the top surface 114, a gameplay display providing a time display 118, a score display 120, a player turn display 122 and a mode display 123, a gameplay control panel 128, a speaker 124 and an optional microphone 126.

The housing 112 of the present game device 100 further comprises a cover portion 132 connected to the main body 130 of the housing 112. In the present embodiment, the cover portion 132 is hingedly connected to the housing 112, however, the cover portion 132 is not limited to being secured to the housing 112 by a hinge and may be secured in any suitable manner. The cover portion 132 supports an additional output device. The additional output device is an output display screen 134 for displaying images to the players P of the game device 10. The display screen 134 is preferably a liquid crystal display (LCD) screen, but any appropriate screen may be used. The display screen 134 may display still images, moving images, videos, characters, symbols and graphical patterns. According to one aspect of the present game device 100, the gameplay display may be positioned on the display screen 134 in addition to, or as opposed to, being disposed along the top surface 114 of the housing 112. According to one aspect of the present invention, the game device 100 may provide a graphical-only embodiment where the device provides the display screen 134 but does not provide a speaker 124 or microphone 126.

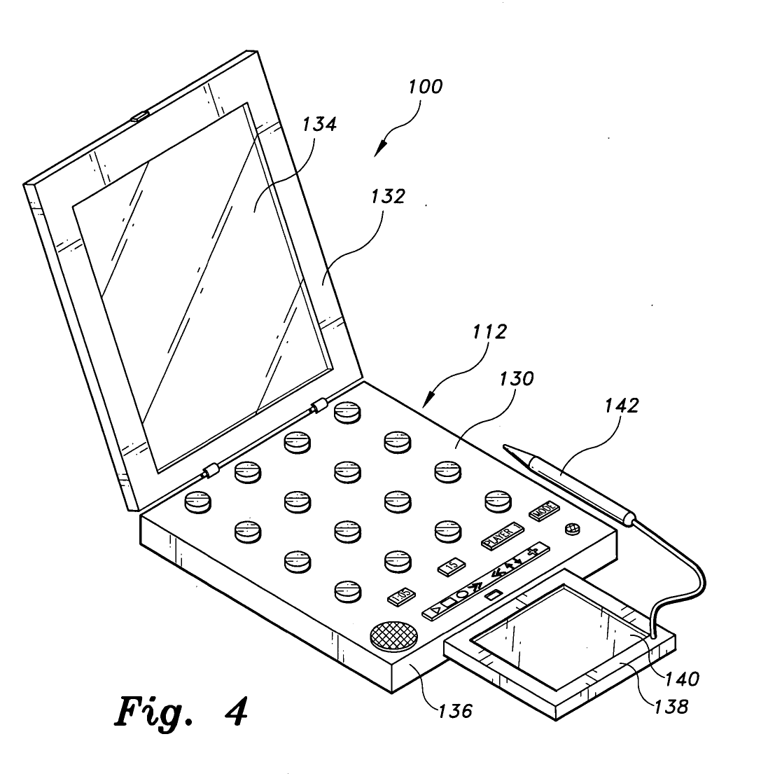

According to one aspect of the present embodiment, the audio/visual game device 100 provides a writing screen 140 and a writing implement 142 (shown in FIG. 4). The writing screen 140 is supported by a tray 138 that is secured to the front edge 136 of the housing 112 of the game device 100. The writing screen may optionally be integrated into the housing 112 itself without the need for the tray 138. The writing screen 140 is an interactive screen that is touch sensitive to the attached writing implement 142. The gameplay display may optionally be displayed on the writing screen 140 so that gameplay selections may be made using the writing implement 142. The writing implement 142 and writing screen 140 may also be used as an input device where the players P of the game may input handwritten words, drawings or symbols for use during the game.

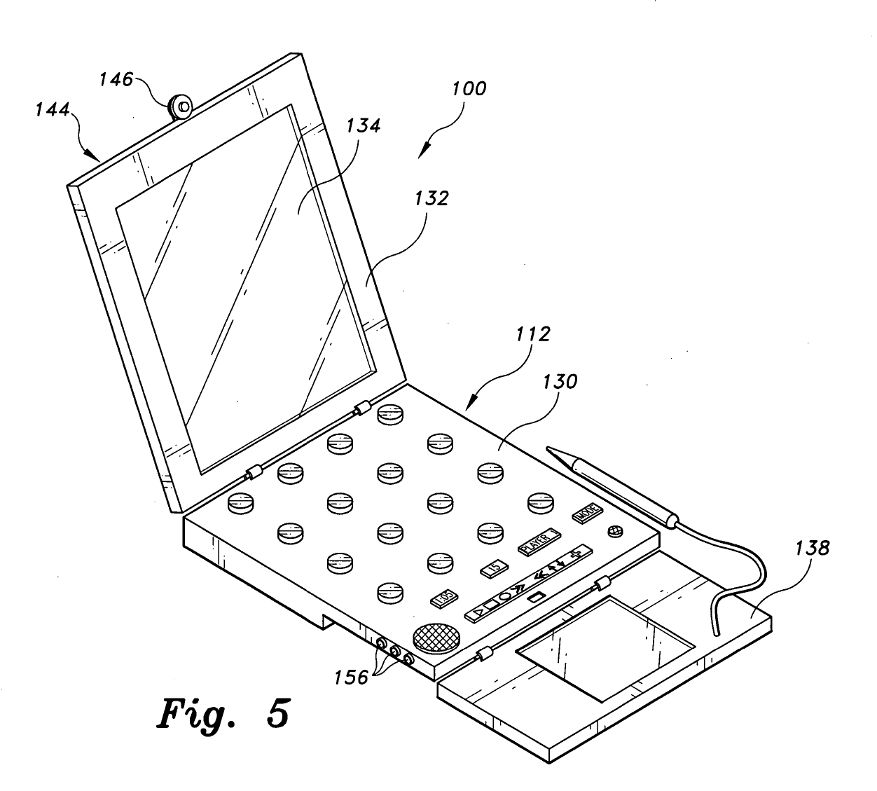

According to another aspect of the present embodiment, the audio/visual game device 100 provides a digital camera 146 (shown in FIG. 5). The digital camera 146 may be disposed along the housing 144. The digital camera 146 may be used to input images and videos into the game device 100 that may be displayed on the display screen 134.

According to another aspect of the present embodiment, the game device 100 provides a RCA jack 156 for transferring game output to an external display unit, such as a television-screen or a personal computer. The RCA jack 156 allows the images from the display screen 134 to be displayed on an external television screen. The gameplay display may also be transferred to and shown on the external screen.

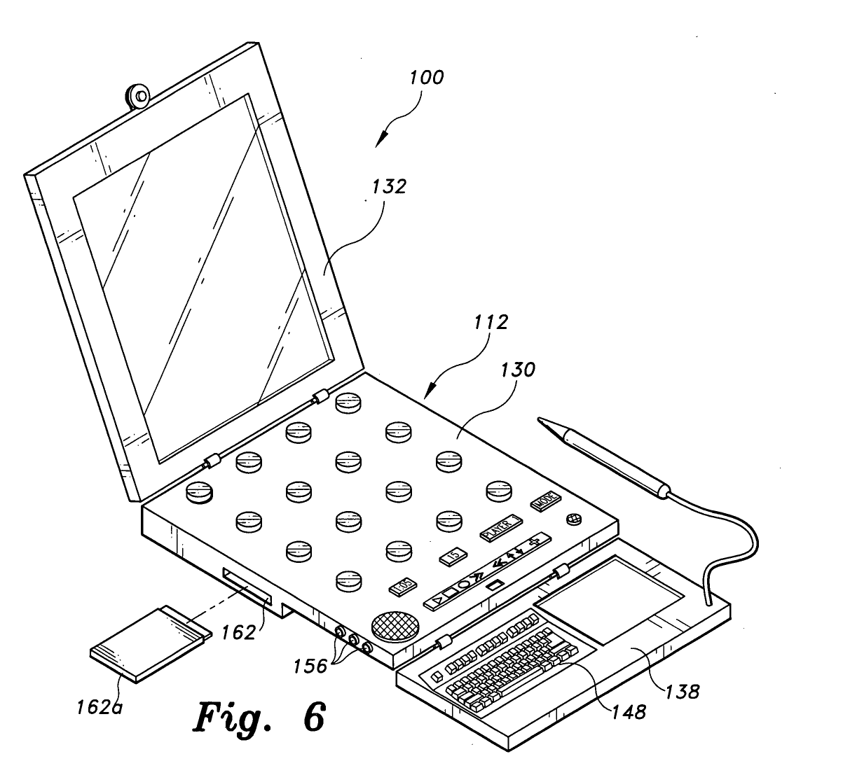

According to another aspect of the present invention, the game device 100 provides a keyboard 148 (as shown in FIG. 6). The keyboard 148 may be disposed along the support tray 138, integrated into the housing 144 or may be an external keyboard that communicates with the game device 100. The keyboard 148 is an additional input device that allows the players P to enter words, characters or symbols into the game device 100. The keyboard 148 may comprise a standard computer keyboard or any other form of data entry keypad.

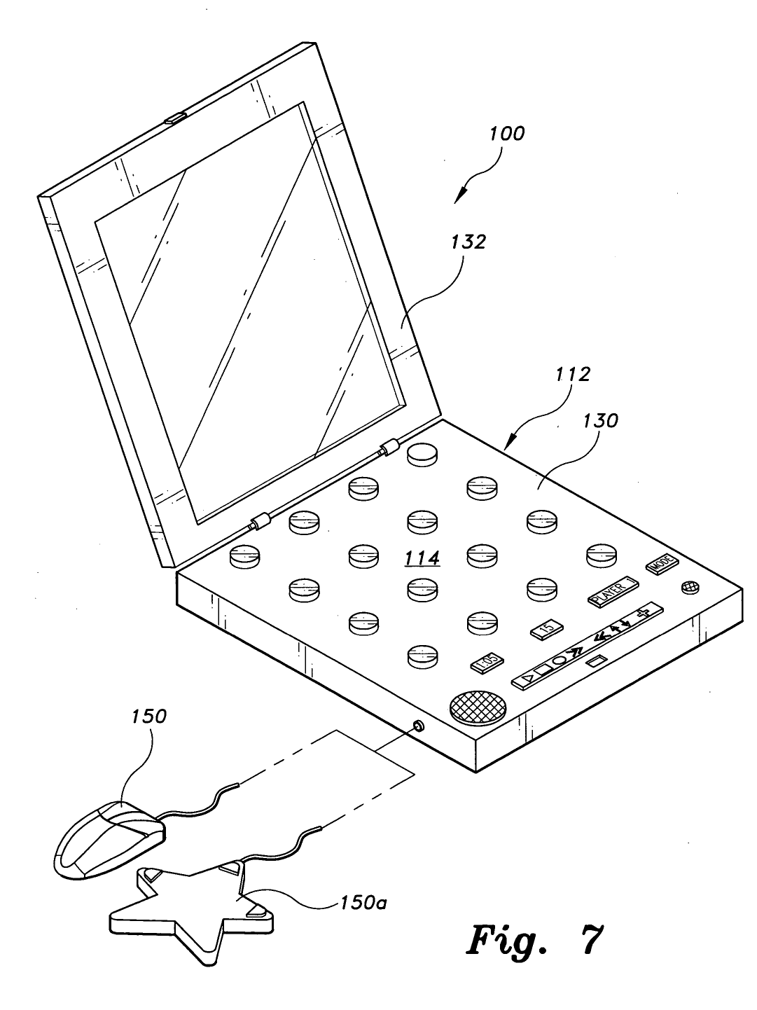

According to another aspect of the present invention, the game device 100 provides a vibrating mouse 150 or toy 150a (as shown in FIG. 7). The vibrating mouse 150 or toy 150a is used to output vibrations, where the vibrations are in a specific sequence that can be matched by the players P. Alternatively, each selection button 116 may be associated with a particular vibration. The players P may match pairs of selection buttons 116 by matching the vibrations. Additionally, a player P may input patterns into the game device 100 by clicking the vibrating mouse 150 or toy 150a in a certain sequence. The pattern will be assigned as an output signal to selection buttons 116. The vibrating mouse 150 and toy 150a may be secured to the game device 100 by a cord, or the vibrating device may be wireless.

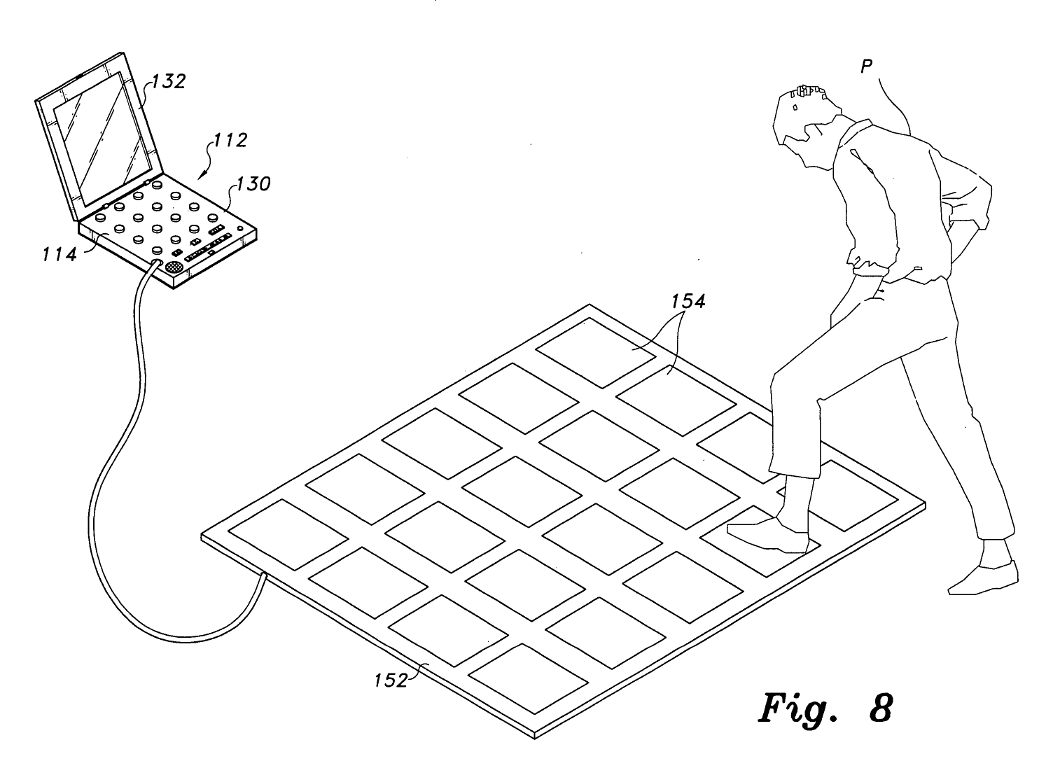

According to another aspect of the present invention, the game device 100 provides a footpad 152 (as shown in FIG. 8) that is in direct communication with the game device 100. The footpad 152 provides a plurality of foot selection buttons 154 disposed on the top surface of the footpad 152. The players P of the game may use the foot selection buttons 154 as opposed to the selection buttons 116 on the housing 112 of the game device 100. The footpad 152 may be connected to the game device 100 by a cord (as shown in FIG. 8), or the footpad 152 may be a wireless device. The selection buttons 116 may also be displayed on the display screen 134 and the players P may use the display screen 134 as an interactive touch screen for making their selections.

The preferred embodiments of the present game device 100 may support some or all of the input and output options discussed above.

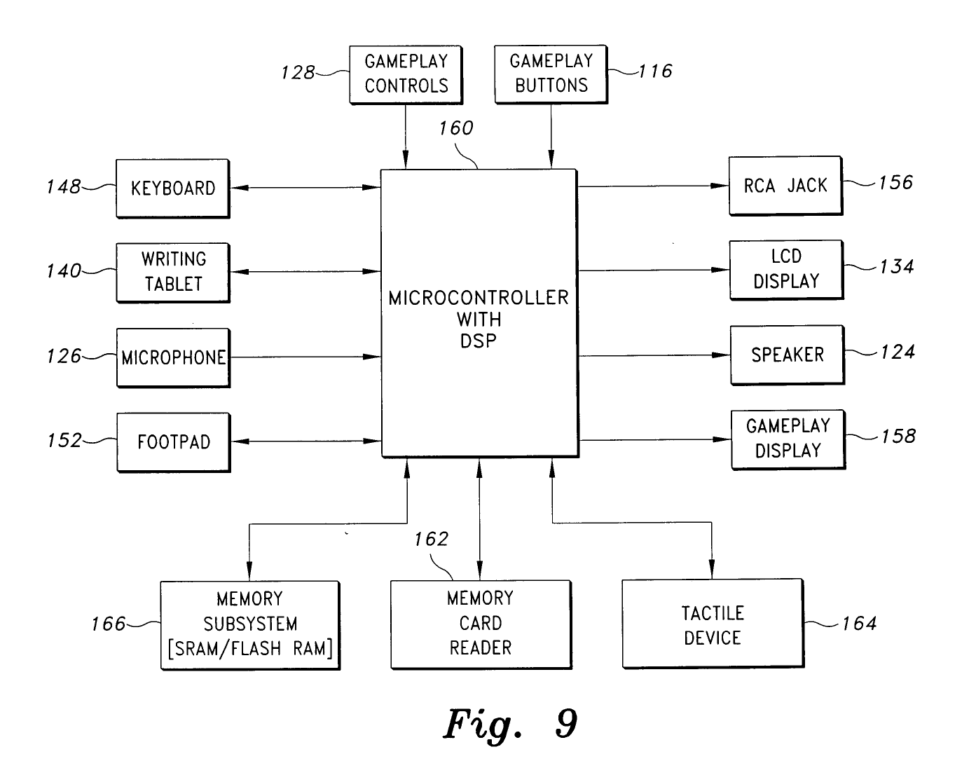

FIG. 9 depicts the internal components of the game device 100 in relation to the external components. The internal components of the game device 100 are stored inside of the housing 112. The game device 100 includes an internal microcontroller 160 that controls the functions of the game device 100. The internal components of the game device 100 also comprise a memory subsystem 166, a memory card reader 162 and a tactile device 164 that each transfer data to and from the microcontroller 160. The memory card reader 162 is disposed along the side of the housing 112 (shown in FIG. 6). The memory card reader 162 comprises a slot for receiving a memory card 162a containing readable data that may provide input data that is used for generating and assigning output signals to the selection buttons 116.

The main function of the microcontroller 160 is to generate output signals and assign each output signal to a specific selection button 116. The output signals will be generated in matching sets. The output signals may include images, sounds, phrases, pictures, words, videos or symbols. The output signals are generated in pairs and are each assigned to a specific selection button. The pairs may include identical signals, such as identical images or sounds, or they may include signals that relate to one another, such as matching lower case and upper case letters, or pictures of animals and their babies.

The microcontroller 160 receives data from the gameplay controls 128 to determine the parameters of the particular game. The microcontroller 160 may randomly generate the output signals and assign them randomly to the selection buttons 116, or the microcontroller may receive input from the keyboard 148, the writing screen 140, the microphone 126, the memory card reader 162 or the digital camera 146. The microcontroller 160 may use the inputted data to generate the output signals. The microcontroller 160 will then display the output through one of the output devices, including the RCA jack 156, the LCD display 143, the speaker 124 or the tactile device 164.

The microcontroller 160 also distinguishes whether or not a match has been made and how many matches each player P makes. The microcontroller 160 keeps track of which selection buttons 116 match one another. Finally, the microcontroller 160 has the ability to manipulate inputted data to create new data. The microcontroller 160 may manipulate the volume, pitch and length of audio data, the pixels in a drawing or image may be zoomed, speed of a video may be changed and the font, size and order of characters or symbols may be changed. Using data manipulation allows a single word, drawing, video or image to be entered into the game device 100 to create an entire set of output signals. For example, given the sound clip of a player P saying “hello”, the game device 100 will be able to manipulate the pitch of the sound creating several new instances of the original sound clip with different pitches. The microcontroller 160 will create an identical match for each pitch created. Enough matching pitches will be created to fill all of the selection buttons 116.

The players P may input their own data, use data stored inside of the microcontroller 160 or retrieve data from the memory card reader 162. The stored data may include matching pictures of animals with animal sounds, animal names and animal sounds, or matching notes in a musical scale. The players P will also have the option of manipulating the data already stored in the microcontroller 160.

Using a set of output signals the microcontroller 160 will divide up each match in the set and assign each instance of a match to a different selection button 116 on the game device 100. The audio only game device 10, shown in FIG. 2, and the audio/visual game device 100, shown in FIG. 3, may each be played by a single player P or by multiple players P and are each played in the same manner as follows.

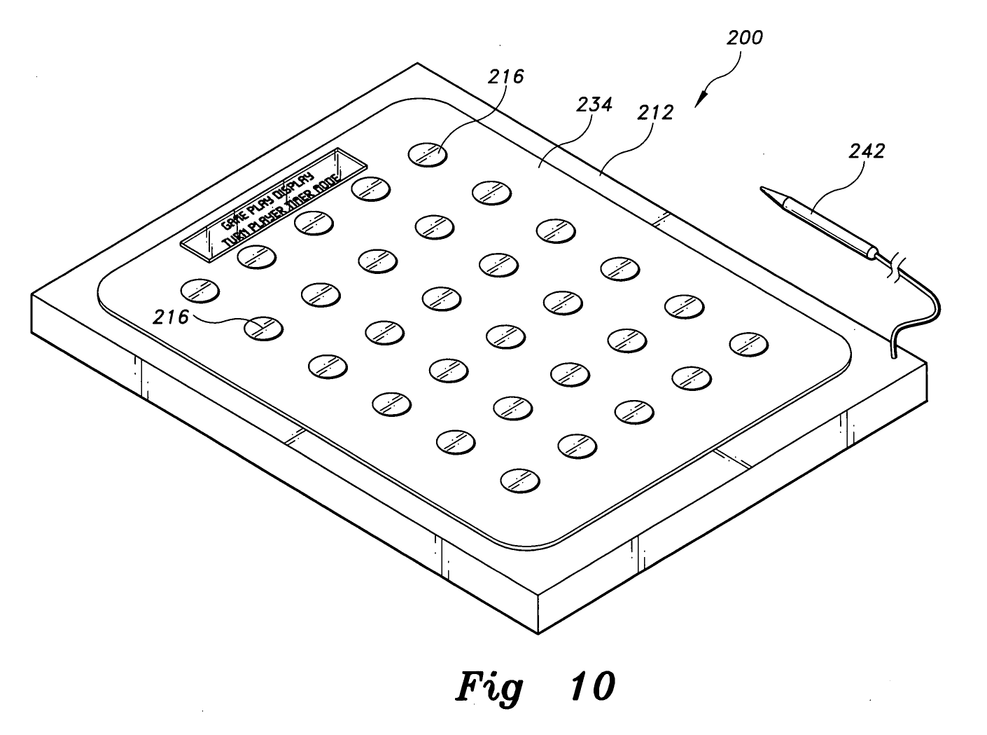

FIG. 10 depicts an additional embodiment of the present invention. The game device 200 according to the present embodiment provides a housing 212 having a touch screen 234 disposed on the top surface of the housing 212. A plurality of selection buttons 216, in the form of interactive images, is displayed on the touch screen 234. A gameplay display is also displayed along the top of the touch screen 234. The touch screen 234, in addition to displaying the images of the selection buttons 216, may also display visual, graphical output signals. A writing implement 242 is provided for interacting with the touch screen 234. The embodiment in FIG. 10 is a visual only game device 200, however the game device 200 may also be provided with an audio output and input device.

In one player mode the game device 100 keeps track of how many matches the player P is able to identify within a particular time frame. When the game begins the game device 100 prompts the player P to select a first button 116. When the player P selects the button 116, the game device 100 outputs the signal that is associated with the particular button 116. The game device 100 then prompts the player P to select another button 116. If the output signal associated with the second button 116 matches the output signal associated with the first button 116 there is a match, and the game device 100 credits the player P with having found a match. The game device 100 then deactivates the matched selection buttons 116 so that the player P can no longer select those buttons 116. If the selected buttons 116 do not match, then they are reset. The game continues until the time elapses or the player locates all of the matching selection buttons 116.

In another configuration of the one player mode, the game is played the same as above with one exception. If the data of the selected buttons 116 does not constitute a match, then the second selection button 116 chosen is reset as if it had never been pushed, but the first selection button 116 chosen remains revealed and the player P must continue selecting buttons 116 until a match is found.

In the multiple player mode the game device 100 keeps record of how many matches each player P is able to identify within a given game. Players P take turns identifying matches. During a player's P turn that player P has the opportunity to uncover a match. If he uncovers a match, that player's P turn continues. A player's P turn continues until that player P fails to identify a match. The game continues until one player P has found the majority of the matches, or until the game device 100 has been cleared.

In another configuration of the multiple player mode, the game device 100 keeps track of how long it takes each player P to clear the game device 100. Each player P has a chance to clear the entire game device 100 by finding all possible matches. The winner is determined by the game device 100 based on which player P identifies all of the matching selection buttons 116 in the fastest time. One particular option of the present game mode is to vary the data associated with the selection buttons 116 during each player's P turn so that each player P is given a different arrangement of output signals. The set of output signals remains the same, while the arrangement of the output signals on the game device 100 is varied.

According to one aspect of the single player mode and the multiplayer mode, each selection button 116 will have more than one matching button 116. In the case where more than one matching selection button 116 exists, the player P must find all existing matching buttons 116 in one turn to be credited for having found a match.

According to one aspect of the single player mode and the multiplayer mode, the game device 100 will have levels of play where each level increases the difficulty of gameplay. The level of difficulty can be increased by increasing the speed of the timer, or by having the sets of output signals more closely resemble each other.

According to one aspect of the single player mode and the multiplayer mode, the output signals associated with each selection button 116 may be revealed prior to the start of the game. Alternatively, the output signals may remain concealed until the players P begin to choose the selection buttons 116.

According to one aspect of the single player mode and the multiplayer mode, the game device 100 may output a single clue and then the players P must find a matching selection button 116 for the particular clue. Once the clue is matched the game device 100 will produce the next clue.

According to another aspect of the single player mode and the multiplayer mode, the game device 100 will output a sequence of signals, and the players P must choose the appropriate selection buttons 116 in the appropriate order to match the sequence of output signals.

According to one aspect of the single player mode and the multiplayer mode, a first player P will select a specific sequence of signals and the second player P must respond by choosing the appropriate selection buttons 116 to produce a matching sequence.

It is to be understood that the present invention is not limited to the embodiments described above, but encompasses any and all embodiments within the scope of the following claims.

1. An electronic memory game, comprising:
a housing having an exterior surface;
a plurality of manually operable selection buttons;
a microcontroller for generating a plurality of perceptively differentiable output signals and assigning each output signal to one of said selection buttons;
an output device for projecting said output signals;
a gameplay display disposed on the exterior surface of said housing for displaying specific gameplay indicia; and
a gameplay control panel disposed on the exterior surface of said housing for controlling specific aspects of the gameplay;
whereby said plurality of perceptively differentiable output signals comprise a plurality of sets of output signals that are to be matched by matching sets of matching output signals, wherein said microcontroller is responsive to the operation of said selection buttons whereby operation of said selection buttons causes the microcontroller to generate a specific output signal.

2. The electronic memory game according to claim 1, wherein said output device comprises a display screen for displaying the output signals wherein said output signals comprise displayable images.

3. The electronic memory game according to claim 1, wherein said output device comprises a speaker for projecting the output signals when the output signals comprise auditory signals.

4. The electronic memory game according to claim 1, wherein said output device comprises a RCA jack for displaying images on an external television screen or personal computer.

5. The electronic memory game according to claim 1, further comprising at least one input device for inputting data into said microcontroller.

6. The electronic memory game according to claim 5, wherein said input device comprises a microphone for receiving auditory data.

7. The electronic memory game according to claim 5, wherein said input device comprises a writing screen and writing implement.

8. The electronic memory game according to claim 5, wherein said input device comprises a digital camera for inputting images.

9. The electronic memory game according to claim 5, wherein said input device comprises a keyboard.

10. The electronic memory game according to claim 5, wherein said input device comprises a vibrating device.

11. The electronic memory game according to claim 1, wherein said selection buttons comprise a plurality of depressible buttons disposed along the exterior surface of said housing.

12. The electronic memory game according to claim 1, wherein said selection buttons comprise a plurality of touch buttons displayed on an interactive touch screen.

13. The electronic memory game according to claim 1, wherein said selection buttons comprise a plurality of panels disposed along a footpad.

14. The electronic memory game according to claim 5, wherein said input device comprises a memory card reader for retrieving data from a data memory card.

15. A method of playing a single player electronic memory game having a device with a plurality of manually operable selection buttons, comprising the steps of:
randomly assigning a specific output signal to each of the selection buttons;
prompting the user to select a button;
displaying the output signal associated with the specific button selected in the previous step;
prompting the user to select another button in an attempt to match the output signals associated with the selected buttons;
displaying the output signal associated with the specific button selected in the previous step;
notifying the user of whether or not a match has been made;
crediting the user for each successful match made; resetting the selected buttons when a match is not made; and
tracking the amount of time lapsed while the game is played.

16. The method according to claim 15, further comprising the step of inputting data into the game device through an external input device, whereby the data is used as specific output signals.

17. The method according to claim 16, further comprising the step of manipulating the data inputted into the game device.

18. A method of playing a multiplayer electronic memory game having a device with a plurality of manually operable selection buttons, comprising the steps of:
randomly assigning a specific output signal to each of the selection buttons;
prompting a first player to select a button;
displaying the output signal associated with the specific button selected in the previous step;
prompting the first player to select another button in an attempt to match the output signals associated with the selected buttons;
displaying the output signal associated with the specific button selected in the previous step;
notifying the first player of whether or not a match has been made;
prompting a second player to select a button;
displaying the output signal associated with the specific button selected in the previous step;
prompting the second player to select another button in an attempt to match the output signals associated with the selected buttons;
displaying the output signal associated with the specific button selected in the previous step;
notifying the second player of whether or not a match has been made;
crediting each player for each correct match by that player; and
tracking the amount of time lapsed while the game is played.

19. The method according to claim 18, further comprising the step of inputting data into the game device through an external input device, whereby the data is used as specific output signals.

20. The method according to claim 19, further comprising the step of manipulating the data inputted into the game device.
